(19) United States
(12) Patent Application Publication
(10) Pub. No.: US 2006/0278201 A1
(43) Pub. Date: Dec. 14, 2006

(54) Fuel vapor treatment apparatus having absorbent and motor

(75) Inventor: Hiroshi Nakamura, Nishio-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/447,903

(22) Filed: Jun. 7, 2006

(30) Foreign Application Priority Data
Jun. 13, 2005 (JP) 2005-171928

(51) Int. Cl. F02M 33/04

(52) U.S. Cl. 123/519

(57) ABSTRACT

A fuel vapor treatment apparatus connects a fuel tank with an intake port. The fuel vapor treatment apparatus includes a canister, a pump device, and a motor. The canister accommodates an absorbent for absorbing fuel vapor evaporated in the fuel tank. The pump device is located in an atmospheric passage that connects the canister with the atmosphere. The pump device pumps air from the atmosphere into the canister. The motor is located in the atmospheric passage for driving the pump device.

### CROSS REFERENCE TO RELATED APPLICATIONS

This application is based on and incorporates herein by reference Japanese Patent Application No. 2005-171928 filed on Jun. 13, 2005.

### FIELD OF THE INVENTION

The present invention relates to a fuel vapor treatment apparatus that includes an absorbent and a motor.

### BACKGROUND OF THE INVENTION

In general, a fuel vapor treatment apparatus includes an absorbent, such as activated charcoal, accommodated in a canister. Fuel vapor is absorbed into the absorbent, and the absorbed fuel vapor is separated from the absorbent by intake pressure caused by flowing intake air into an internal combustion engine. As ambient temperature around the absorbent becomes high, a performance of separating the fuel vapor from the absorbent is enhanced. According to JP-A-2002-155812, a motor is provided in an absorbent accommodated in a canister. The motor drives a pump.

In this structure, the motor generates heat by driving the pump, thereby applying the heat to the absorbent accommodated in the canister. Thus, temperature of the absorbent is increased, so that separation of the fuel vapor from the absorbent is accelerated. However, in this structure, the absorbent is heated by thermal energy transferred from the motor. Accordingly, the temperature of the absorbent gradually increases. Consequently, the thermal energy transferred from the motor has little effect on heating the absorbent, and hence, separation of fuel vapor from the absorbent may be insufficient.

### SUMMARY OF THE INVENTION

The present invention addresses the above disadvantage. According to one aspect of the present invention, a fuel vapor treatment apparatus connects a fuel tank with an intake port. The fuel vapor treatment apparatus includes a canister that accommodates an absorbent for absorbing fuel vapor evaporated in the fuel tank. The fuel vapor treatment apparatus further includes a pump device that is located in an atmospheric passage connecting the canister with atmosphere. The pump device pumps air from atmosphere into the canister. The fuel vapor treatment apparatus further includes a motor that is located in the atmospheric passage. The motor drives the pump device.

Alternatively, a fuel vapor treatment system is used for an internal combustion engine. The fuel vapor treatment system connects a fuel tank with an intake port. The fuel vapor treatment system includes a canister that accommodates an absorbent for absorbing fuel vapor evaporated in the fuel tank. The fuel vapor treatment system further includes an atmospheric passage that connects the canister with the intake path. The fuel vapor treatment system further includes a pump device that is located in the atmospheric passage. The pump device pumps air into the canister through the inlet path. The fuel vapor treatment system further includes a motor that is located in the atmospheric passage. The motor drives the pump device.

Alternatively, a method, for separating fuel vapor absorbed in an absorbent, includes driving a pump device using a motor so as to pumping air toward the absorbent such that the air flows around the motor. The method further includes transferring heat generated by the motor to the air flowing around the motor. The method further includes heating the absorbent by the air utilizing the heat transferred from the motor.

### BRIEF DESCRIPTION OF THE DRAWINGS

The above and other objects, features and advantages of the present invention will become more apparent from the following detailed description made with reference to the accompanying drawings. In the drawings:

FIG. 1 is an overview showing a fuel vapor treatment apparatus including a pump device and a motor, according to a first embodiment;

FIG. 2 is a partially cross sectional side view showing the pump device and the motor of the fuel vapor treatment apparatus, according to the first embodiment;

FIG. 3 is a view showing the motor when being viewed from the arrow III in FIG. 2;

FIG. 4 is a partially cross sectional side view showing the pump device and a motor of a fuel vapor treatment apparatus, according to a second embodiment;

FIG. 5A is a schematic view showing a plate member manufactured to be an auxiliary yoke of the motor, and FIG. 5B is a schematic view showing the auxiliary yoke, according to the second embodiment.

### DETAILED DESCRIPTION OF PREFERRED EMBODIMENTS

### First Embodiment

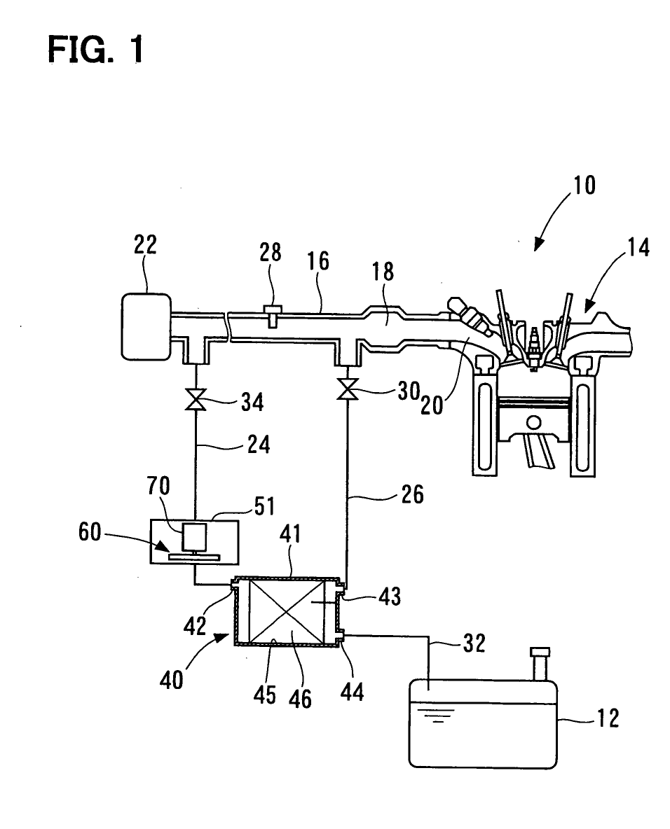

As shown in FIG. 1, fuel is evaporated in a vehicular fuel tank 12 to be fuel vapor. A fuel vapor treatment apparatus 10 introduces the fuel vapor from the fuel tank 12 into an intake pipe 16 of an internal combustion engine 14. The fuel vapor treatment apparatus 10 includes a canister 40, a pump device 60, and a motor 70.

The intake pipe 16 of the engine 14 defines an intake passage 18. The intake passage 18 has one end connecting with an intake port 20 of the engine 14. The intake passage 18 has another end connecting with an air filter 22. The air filter 22 is provided to an inlet path. Intake air is drawn into the intake passage 18 through the inlet path, so that the air filter 22 removes foreign matters contained in intake air. The intake passage 18 connects with an atmospheric passage 24 and a purge passage 26. The atmospheric passage 24 branches from the intake passage 18 on the downstream side of the air filter 22, and connects with the canister 40 through the pump device 60. The purge passage 26 branches from the intake passage 18 on the downstream side of an air flow meter 28 provided to the intake pipe 16, and connects with the canister 40 through a purge valve 30.

The canister 40 has a casing 41. For example, the casing 4 is formed of metal or resin. The casing 41 has an atmospheric port 42, a purge port 43, and a tank port 44. The atmospheric port 42 connects with the intake passage 18 through the pump device 60 and the atmospheric passage 24. The tank port 44 connects with the fuel tank 12 through a tank passage 32.

The canister 40 has a chamber 45 accommodating an absorbent 46. For example, the absorbent 46 is formed of a porous material, for example. The porous material may be activated charcoal or silica gel, for example. The canister 40 connects with the intake passage 18 through the purge port 43 and the purge passage 26. The purge passage 26 is provided with the purge valve 30. The purge valve 30 communicates and blocks the purge passage 26, so that the purge valve 30 controls an amount of air containing fuel vapor and flowing from the canister 40 into the intake passage 18.

The canister 40 connects with the intake passage 18 through the atmospheric port 42 and the atmospheric passage 24. The atmospheric passage 24 is provided with the pump device 60 and an atmospheric valve 34.

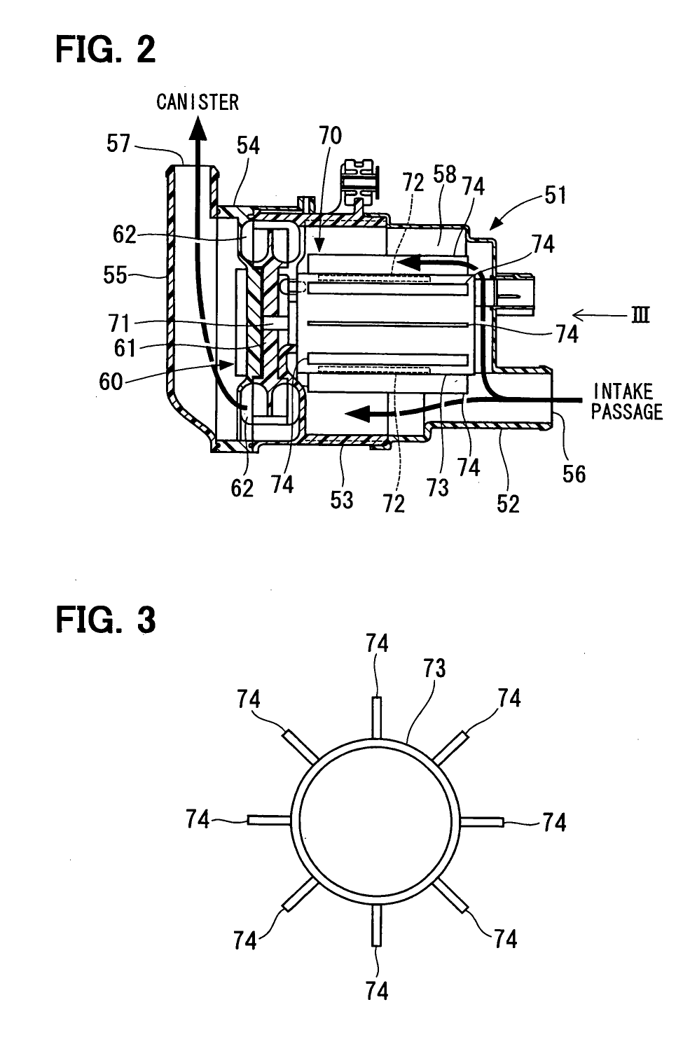

As shown in FIG. 2, the pump device 60 and the motor 70 are accommodated in a housing 51 defining a part of the atmospheric passage 24. The housing 51 includes a first cover 52, a body 53, a casing 54, and a second cover 55. The first cover 52 defines an atmospheric inlet port 56. The second cover 55 defines an atmospheric outlet port 57. The first cover 52, the body 53, and the casing 54 define a chamber 58 between the atmospheric inlet port 56 of the first cover 52 and the atmospheric outlet port 57 of the second cover 55. The chamber 58 accommodates the motor 70. For example, the motor 70 may be a DC motor or an AC motor. The motor 70 includes a shaft 71 for rotating with a movable member (not shown). The end of the shaft 71 on the side of the atmospheric outlet port 57 connects with a rotative member 61. The body 53 and the casing 54 define a pump chamber 62 therebetween. The rotative member 61 is accommodated in the pump chamber 62. The motor 70 rotates the rotative member 61, so that air is drawn from the atmospheric inlet port 56 into the pump chamber 62, and is pressurized in the pump chamber 62. The air pressurized in the pump chamber 62 is discharged through the atmospheric outlet port 57. The pump device 60 is constructed of the body 53 and the casing 54, which define the pump chamber 62, and the rotative member 61, which pressurizes air in the pump chamber 62. The atmospheric inlet port 56, the chamber 58, and the pump chamber 62, and the atmospheric outlet port 57, which are defined in the housing 51, construct a part of the atmospheric passage 24.

The motor 70 includes a yoke 73 for accommodating a permanent magnet 72 and the movable member (not shown). The permanent magnet 72 serves as a stator. The yoke 73 is formed of metal such as ferrous material to be in a substantially cylindrical shape.

As shown in FIGS. 2, 3, the yoke 73 has fins 74 that protrude outwardly with respect to the radial direction of the yoke 73. In this embodiment, the yoke 73 has eight fins 74, for example. The eight fins 74 are arranged circumferentially at substantially regular intervals. The number of the fins 74 and the intervals of the fins 74 may be determined as appropriate. As referred to FIG. 2, each of the fins 74 extends substantially throughout the axial length of the yoke 73, for example. In this structure, air flows from the atmospheric inlet port 56 into the chamber 58 defined in the housing 51, and the air passes along the fins 74 around the outer periphery of the motor 70, and enters into pump chamber 62.

Next, an operation of the fuel vapor treatment apparatus 10 is described.

As fuel is vaporized in the fuel tank 12, pressure in the fuel tank 12 increases, so that air containing fuel vapor flows from the fuel tank 12 into the canister 40. When the engine 14 stops, the atmospheric valve 34 opens, so that the atmospheric passage 24 is vent to the atmosphere through the air filter 22. As pressure in the fuel tank 12 increases, air is discharged from the fuel tank 12, and ejected through the air filter 22 after passing through the canister 40 and the atmospheric passage 24. In this condition, fuel vapor evaporated in the fuel tank 12 is introduced into the canister 40, so that the fuel vapor is absorbed into the absorbent 46 accommodated in the chamber 45 of the canister 40.

When the engine 14 is operated, intake air flows through the intake passage 18 defined in the intake pipe 16. Therefore, pressure on the side of the intake passage 18 decreases, so that pressure in the canister 40, which connects with the intake passage 18 through the purge passage 26, decreases. In this condition, the atmospheric valve 34 opens, and the motor 70 drives the pump device 60, so that air is introduced into the canister 40 through the air filter 22 and the atmospheric passage 24. The air introduced into the atmospheric passage 24 is further introduced into the housing 51 through the atmospheric inlet port 56. The air introduced into the interior of the housing 51 flows into the pump chamber 62 along the fins 74 of the motor 70. In this situation, the air flowing from the atmospheric inlet port 56 into the pump chamber 62 is heated by thermal energy transferred from the motor 70, by passing around the outer periphery of the motor 70 along the fins 74. That is, when the pump device 60 is operated, the motor 70 generates heat by driving the pump device 60. Thus, the introduced air is heated by flowing into the housing 51 and passing around the motor 70. Furthermore, the motor 70 is cooled by the air flowing into the housing 51 and passing around the motor 70. The heated air is pressurized in the pump chamber 62, and is discharged through the atmospheric outlet port 57. The arrows depicted in FIG. 1 shows the airflow.

Air discharged through the atmospheric outlet port 57 flows into the canister 40 through the atmospheric port 42 of the canister 40. The air flowing into the canister 40 passes through the absorbent 46 accommodated in the chamber 45. In this situation, the air heated by the motor 70 is introduced into the interior of the canister 40, so that the absorbent 46 is heated by the air. As temperature of the absorbent 46 becomes high, separation of fuel vapor absorbed into the absorbent 46 is accelerated. Thus, a performance of separating fuel from the absorbent 46 accommodated in the canister 40 can be enhanced by introducing air, which is heated using the motor 70, into the interior of the canister 40. Furthermore, heated air flows from the atmospheric port 42 into the absorbent 46 accommodated in the canister 40. Therefore, the heated air substantially uniformly flows into the absorbent 46, so that the absorbent 46 can be substantially uniformly heated. In addition, temperature of the air introduced into the interior of the canister 40 is high, so that the absorbent 46 can be quickly heated.

Air passes through the absorbent 46 in the canister 40, so that fuel vapor absorbed into the absorbent 46 is separated from the absorbent 46. Intake air flows through the intake passage 18, so that suction pressure is generated in the intake passage 18. Therefore, fuel vapor removed from the absorbent 46 flows into the purge passage 26 together with air introduced from the atmospheric passage 24. The purge valve 30 blocks and communicates the purge passage 26, thereby controlling the amount of air, which contains fuel vapor, flowing from the purge passage 26 into the intake passage 18. The air, which flows from the canister 40 into the intake passage 18 through the purge passage 26, contains fuel vapor being in a relatively high concentration. Therefore, the purge valve 30 controls the flow amount of the air, which is introduced from the canister 40 to be mixed with intake air in the intake passage 18, in order to maintain an air/fuel ratio of intake air flowing into the engine 14 at a predetermined value.

In this embodiment, air is heated by the motor 70, which drives the pump device 60, and the air is introduced into the canister 40. Therefore, the absorbent 46 is quickly and substantially uniformly headed in the canister 40, so that separation of fuel vapor from the absorbent 46 can be accelerated. In addition, the motor 70 is cooled by the introduced air. Therefore, an additional cooling member for enhancing cooling performance of the motor 70 need not be provided around the motor 70. Thus, the motor 70 can be restricted from being jumboized.

### Second Embodiment

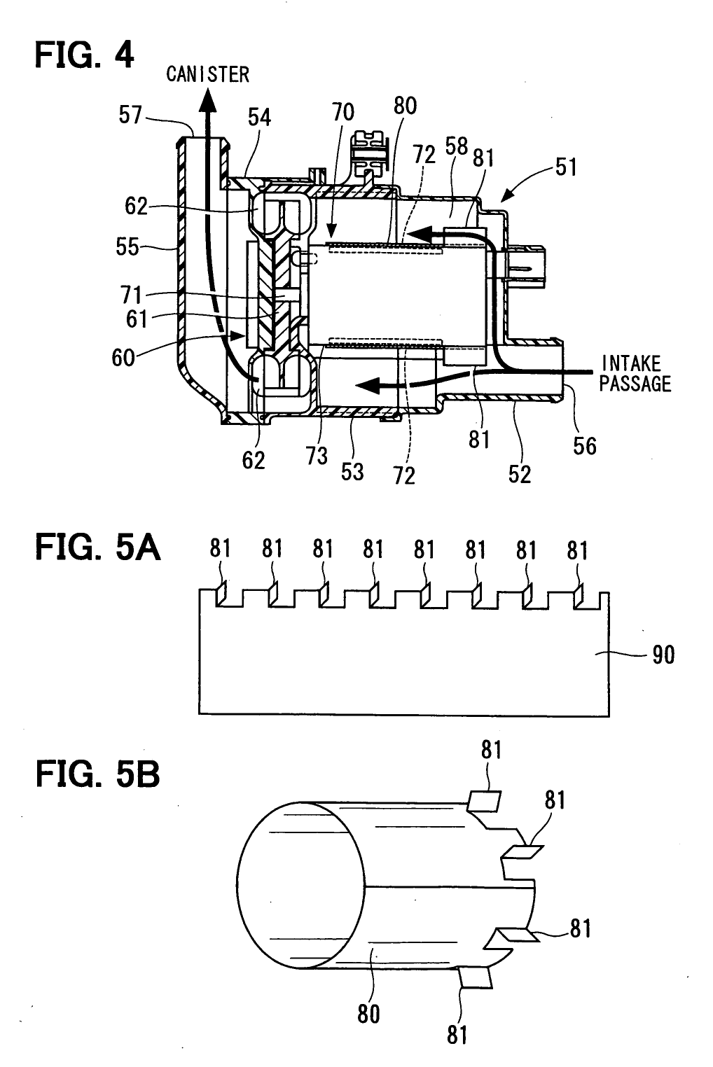

As shown in FIG. 4, in this embodiment, the outer periphery of the yoke 73 of the motor 70 is provided with an auxiliary yoke member 80. The auxiliary yoke member 80 may be press-fitted to or loosely fitted around the outer periphery of the yoke 73. In this structure, the inner periphery of the auxiliary yoke member 80 makes contact with the outer periphery of the yoke 73. The auxiliary yoke member 80 is formed of a magnetic material, thereby securing magnetic flux sufficiently around the outer periphery of the yoke 73. The auxiliary yoke member 80 is located around the outer periphery of the permanent magnet 72, which is provided to the interior of the yoke 73, for securing magnetic flux flow. The end of the auxiliary yoke member 80 on the opposite side of the rotative member 61 has fins 81. In this structure, the fins 81 are axially distant from the permanent magnet 72. Thus, the flow of the magnetic flux can be restricted from being disturbed due to providing the fins 81 to the auxiliary yoke member 80. The arrows depicted in FIG. 4 shows the airflow.

The auxiliary yoke member 80 is in a substantially cylindrical shape. For example, the auxiliary yoke member 80 can be formed in the following manner. As shown in FIG. 5A, the fins 81 are formed in a substantially plate-shaped member 90. Subsequently, as shown in FIG. 5B, the substantially plate-shaped member 90 is rolled into the substantially cylindrical shape, so that the auxiliary yoke member 80 can be manufactured. In this structure, the fins 81 and the substantially plate-shaped member 90, which is to be the auxiliary yoke member 80, can be readily formed by press-forming, for example.

The above structures of the embodiments can be combined as appropriate.

Various modifications and alternations may be diversely made to the above embodiments without departing from the spirit of the present invention.

What is claimed is:

1. A fuel vapor treatment apparatus connecting a fuel tank with an intake port, the fuel vapor treatment apparatus comprising:
a canister that accommodates an absorbent for absorbing fuel vapor evaporated in the fuel tank;
a pump device that is located in an atmospheric passage connecting the canister with atmosphere, the pump device pumping air from atmosphere into the canister; and
a motor that is located in the atmospheric passage, the motor driving the pump device.

2. The fuel vapor treatment apparatus according to claim 1, further comprising:
a housing that has an inlet port and an outlet port, the inlet port connecting with atmosphere, the outlet port communicating with the canister,
wherein the housing has a chamber that accommodates the pump device and the motor between the inlet port and outlet port.

3. The fuel vapor treatment apparatus according to claim 2,
wherein the motor has a plurality of fins, each radially and outwardly protrudes, and
the plurality of fins are circumferentially arranged.

4. The fuel vapor treatment apparatus according to claim 3, wherein the motor includes a yoke that is integrally formed with the plurality of fins.

5. The fuel vapor treatment apparatus according to claim 3,
wherein the motor includes a yoke and an auxiliary yoke member,
the auxiliary yoke member is formed of a magnetic material,
the auxiliary yoke member is arranged around an outer periphery of the yoke, and
the auxiliary yoke member is integrally formed with the plurality of fins.

6. A fuel vapor treatment system for an internal combustion engine, the fuel vapor treatment system connecting a fuel tank with an intake port, the fuel vapor treatment system comprising:
a canister that accommodates an absorbent for absorbing fuel vapor evaporated in the fuel tank;
an atmospheric passage that connects the canister with an inlet path;
a pump device that is located in the atmospheric passage, the pump device pumping air into the canister through the inlet path; and
a motor that is located in the atmospheric passage, the motor driving the pump device.

7. The fuel vapor treatment system according to claim 6, further comprising:
a filter that is provided to the inlet path,
wherein the filter removes foreign matters contained in the air.

8. The fuel vapor treatment system according to claim 6, further comprising:
a housing that has an inlet port and an outlet port, the inlet port connecting with the inlet path, the outlet port communicating with the canister,
wherein the housing has a chamber that accommodates the pump device and the motor between the inlet port and outlet port.

9. The fuel vapor treatment system according to claim 8,
wherein the motor has a plurality of fins, each radially and outwardly protrudes, and
the plurality of fins are circumferentially arranged.

10. The fuel vapor treatment system according to claim 9, wherein the motor includes a yoke that is integrally formed with the plurality of fins.

11. The fuel vapor treatment system according to claim 9,
wherein the motor includes a yoke and an auxiliary yoke member,
the auxiliary yoke member is formed of a magnetic material,
the auxiliary yoke member is arranged around an outer periphery of the yoke, and
the auxiliary yoke member is integrally formed with the plurality of fins.

12. The fuel vapor treatment system according to claim 6, further comprising:
an atmospheric valve that is located in the atmospheric passage,
wherein the atmospheric valve is adapted to communicating the inlet path with the canister, and
the atmospheric valve is adapted to blocking the inlet path from the canister.

13. The fuel vapor treatment system according to claim 12, further comprising:
a purge passage that connects the canister with the internal combustion engine; and
a purge valve that is provided to the purge passage,
wherein the purge valve is adapted to communicating the canister with the internal combustion engine, and
the purge valve is adapted to blocking the canister from the internal combustion engine.

14. A method for separating fuel vapor absorbed in an absorbent, the method comprising:
driving a pump device using a motor so as to pumping air toward the absorbent such that the air flows around the motor;
transferring heat generated by the motor to the air flowing around the motor; and
heating the absorbent by the air utilizing the heat transferred from the motor.

15. The method according to claim 14, further comprising:
introducing air from atmosphere into the pump device.
